(19) United States
(12) Patent Application Publication
(10) Pub. No.: US 2011/0098060 A1
(43) Pub. Date: Apr. 28, 2011

(54) WIRELESS DIRECTION SYSTEM AND METHOD

(75) Inventor: CHAO-TSUNG FAN, Tu-Cheng (TW)

(73) Assignee: HON HAI PRECISION INDUSTRY CO., LTD., Tu-Cheng (TW)

(21) Appl. No.: 12/618,760

(22) Filed: Nov. 15, 2009

(30) Foreign Application Priority Data
Oct. 26, 2009 (CN) 200910308781.X

(51) Int. Cl. H04W 24/00; H04M 1/00

(52) U.S. Cl. 455/456.3; 455/556.1

(57) ABSTRACT

A wireless direction system provides service information. A comparison module logs onto a data server via a base station by wireless internet access, and outputs service information corresponding to location coordinates of a portable device in response to the data server storing the service information. A service information processing module receives the service information and provides it to users.

### BACKGROUND

1. Technical Field

The present disclosure relates to wireless direction systems and methods, and particularly to a wireless direction system and method for providing timely service information.

2. Description of Related Art

Currently, displays are often provided for generating and displaying service information, such as directions in a park or exhibition venue. The information may also be provided in the form of audio output, literature, and other similar ways to attract. However, with these methods, time must be spent locating the displays or other devices before the information can be delivered.

### BRIEF DESCRIPTION OF THE DRAWINGS

FIG. 1 is a schematic diagram of an exemplary embodiment of a wireless direction system, the direction system including a portable device.

FIG. 2 is a block diagram of the portable device of FIG. 1.

FIG. 3 is a flowchart of an exemplary embodiment of a wireless direction method.

### DETAILED DESCRIPTION

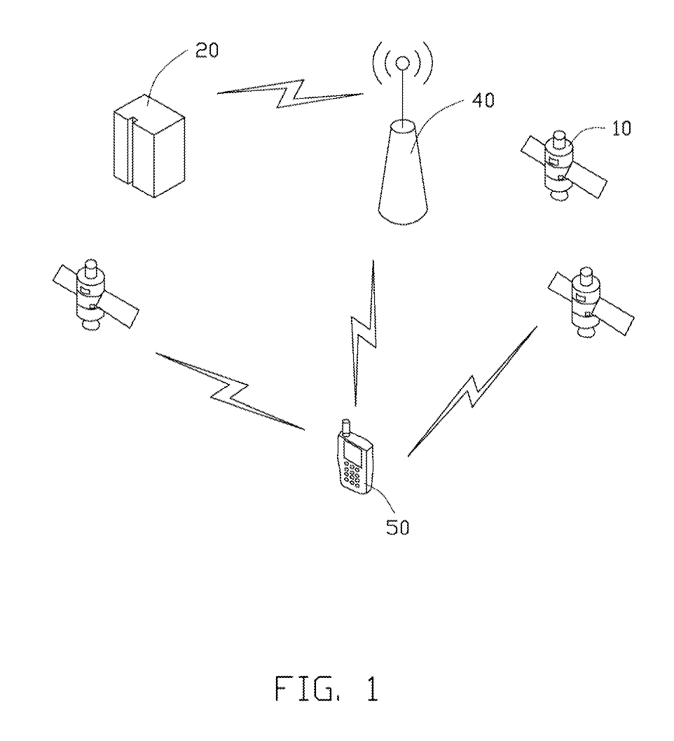

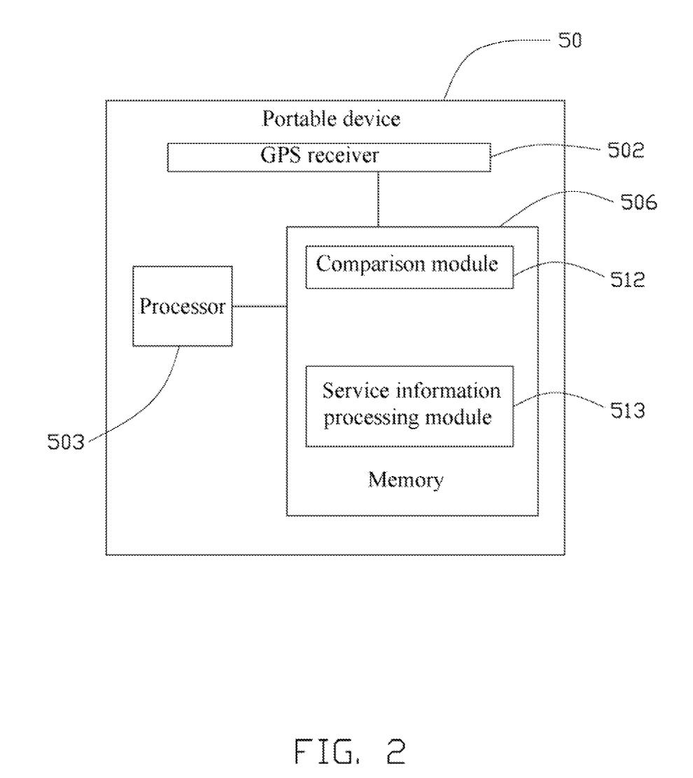

Referring to FIGS. 1 and 2, an exemplary embodiment of a wireless direction system includes a global positioning system (GPS), a data server 20, a base station 40, and a portable device 50. The GPS includes a plurality of satellites 10. In this embodiment, the data server 20 stores service information, for example, introductions to areas of the venue utilizing video and audio content. In one embodiment, the portable device 50 may be a mobile phone, a notebook computer, or other kind of portable device.

The portable device 50 includes a GPS receiver 502, a processor 503, and a memory 506 connected to the GPS receiver 502 and the processor 503. The memory 506 includes a comparison module 512 and a service information processing module 513, each of which stores one or more computerized instructions to be executed by the processor 503.

The GPS receiver 502 receives signals output from the plurality of satellites 10 after every predetermined interval, for example, three minutes, and calculates location coordinates of the portable device 50. In one embodiment, the location coordinates of the portable device 50 may include a longitude, a latitude, and an altitude of the portable device 50.

The comparison module 512 logs onto the data server 20 via the base station 40 by wireless internet access, and determines whether service information corresponding to the location coordinates of the portable device 50 is present on the data server 20. The comparison module 512 sends the service information to the service information processing module 513 in response to successful locating of the service information corresponding to the location coordinates of the portable device 50.

The service information processing module 513 receives the service information and provides it to users.

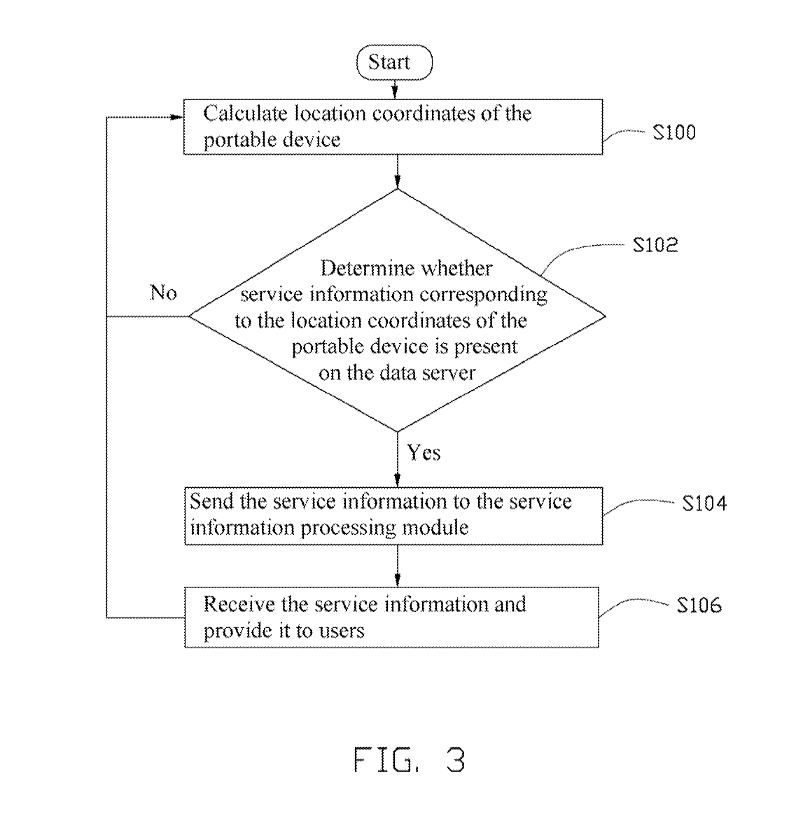

FIG. 3 is a flowchart of an exemplary embodiment of a wireless direction method. The method includes the following steps.

In step S100, the GPS receiver 502 receives signals output from the plurality of satellites 10, and calculates location coordinates of the portable device 50.

In step S102, the comparison module 512 logs onto the data server 20 via the base station 40 by wireless internet access, and determines whether service information corresponding to the location coordinates of the portable device 50 is present on the data server 20. If the service information corresponding to the location coordinates of the portable device 50 is located, step S104 is implemented. If not, step S100 is repeated.

In step S104, the comparison module 512 sends the service information to the service information processing module 513.

In step S106, the service information processing module 513 receives the service information and provides it to users, and the procedure returns to step S100.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A wireless direction system comprising:
a plurality of satellites;
a data server storing service information;
a base station for mobile communications; and
a portable device comprising a processor, a global positioning system (GPS) receiver to receive signals output from the plurality of satellites after every predetermined interval and calculate location coordinates of the portable device, and a memory connected to the GPS receiver and the processor, the memory comprising a plurality of modules each of which stores one or more computerized instructions to be executed by the processor, wherein the plurality of modules comprises:
a comparison module to log onto the data server via the base station by wireless internet access, determine whether service information corresponding to the location coordinates of the portable device is present on the data server, and output the located service information; and
a service information processing module to receive the service information and provide it to users.

2. The system of claim 1, wherein the portable device is a mobile phone.

3. The system of claim 1, wherein the portable device is a notebook computer.

4. A wireless direction method comprising:
receiving signals output from a plurality of satellites, and calculating location coordinates of a portable device;
logging onto a data server via a base station by a wireless internet access, determining whether service information corresponding to the location coordinates of the portable device is present on the data server, and outputting the located service information; and
receiving the service information and providing the service information to users.

5. The method of claim 4, wherein the portable device is a mobile phone.

6. The method of claim 4, wherein the portable device is a notebook computer.
